(19) United States
(12) Patent Application Publication
(10) Pub. No.: US 2023/0195092 A1
(43) Pub. Date: Jun. 22, 2023

(54) PRODUCTION LINE FOR MANUFACTURING PACKAGED PRODUCTS WITH PREDICTIVE DETERMINATION OF REQUIRED OPERATOR INTERACTION

(71) Applicant: MULTIVAC SEPP HAGGENMUELLER SE & CO. KG, Wolfertschwenden (DE)

(72) Inventor: Wolfgang BUCHENBERG, Wiggensbach (DE)

(73) Assignee: MULTIVAC SEPP HAGGENMUELLER SE & CO. KG, Wolfertschwenden (DE)

(21) Appl. No.: 18/086,927

(22) Filed: Dec. 22, 2022

(30) Foreign Application Priority Data
Dec. 22, 2021 (DE) 102021134345.3

(51) Int. Cl. G05B 19/418

(52) U.S. Cl. CPC G05B 19/4188; G05B 2219/31229

(57) ABSTRACT

A production line for manufacturing packaged products includes a plurality of workstations for performing different operations. Each of the workstations is configured to predictively determine time data during operation that define, as an interaction time, a time of an operator interaction with the respective workstation required in the future. The production line includes a central processing unit. The workstations are configured to transmit the time data to the central processing unit.

### CROSS-REFERENCE TO RELATED APPLICATIONS

This application claims foreign priority benefits under 35 U.S.C. § 119(a)-(d) to German Patent Application Number DE 10 2021 134 345.3, filed Dec. 22, 2021, which is incorporated by reference in its entirety.

### TECHNICAL FIELD

The present disclosure relates to production lines for manufacturing packaged products with multiple workstations.

### BACKGROUND

For the production of packaged food products, it is known from practice to provide production lines including a slicing station, a thermoforming packaging machine and a labelling station as workstations. At the slicing station, food products, for example cheese or sausages, are sliced. The sliced food products are then packaged in the packaging machine. The packaging machine may be designed, for example, as a thermoforming packaging machine or as a traysealer. In the labelling station, labels are applied to the packages.

In known production lines, it may be necessary for one or more actions to be performed by an operator at a workstation in certain operating situations. For example, the operator may be required to replace a foil supply roll of the packaging machine or to replenish a label supply of the labelling station. Such operations, and others required for continued operation, may result in downtime of the production line, thereby reducing production output.

### SUMMARY

It is an object of the disclosure to provide a way of operating a production line for producing packaged products in an efficient manner.

According to an aspect of the disclosure, a production line for manufacturing packaged products is provided. The production line includes a plurality of workstations for performing different operations. The workstations are each configured to predictively determine, during operation, time data defining a time of an operator interaction with the respective workstation required in the future as an interaction time. The production line includes a central processing unit. The workstations are configured to transmit the time data to the central processing unit.

Since the time data are determined in advance, timely preparation for the operator interaction becomes possible so that the operator interaction may then be performed promptly, efficiently, and quickly. The time data may simplify the work organization of operators on the production line.

By transmitting the time data to the central processing unit, the time data from the individual workstations are available centrally. This facilitates coordination of the operation of the individual workstations and the corresponding operator interactions. The central processing unit may use the time data from the individual workstations to improve and/or facilitate the operation of the production line.

The time data may define the time of the corresponding operator interaction in various ways. For example, the time data may directly specify the time, at which the operator interaction is required, such as an indication of a day time or an indication of a machine time. Alternatively, the time data may indirectly specify the time, at which the corresponding operator interaction will be required, for example by specifying a time remaining until the time, at which the operator interaction is required.

Preferably, transmitting the time data to the central processing unit is performed prior to the occurrence of the interaction time, in particular at least 10 seconds, or at least 30 seconds, or at least 60 seconds, or at least 120 seconds, or at least 300 seconds, or at least 600 seconds prior to the occurrence of the interaction time.

Transmitting the time data to the central processing unit may be accomplished via a wired communication link or a wireless communication link. Transmitting the time data to the central processing unit may be accomplished via a communication bus.

The workstations may be configured to transmit to the central processing unit interaction data that correspond to the time data. The interaction data may define a type of operator interaction required at the corresponding interaction time. The combination of time data and corresponding interaction data provides the central processing unit with information on the operator interaction required at a given time. This facilitates an appropriate response.

For example, the interaction data may include information relating to which workstation requires the operator interaction. Alternatively or additionally, the interaction data may include information on the type of actions required in the course of the operator interaction. Alternatively or additionally, the interaction data may include information about why the operator interaction is required. Alternatively or additionally, the interaction data may include instructions for performing the operator interaction.

The interaction data may include an identifier associated with the operator interaction. The central processing unit may be configured to associate the identifier with an operator interaction based on a table, or to perform one or more associated actions based on the identifier. The one or more actions may include, for example, displaying operator information associated with the identifier or outputting a message associated with the identifier.

The central processing unit may be configured to determine a next upcoming operator interaction based on time data from the workstations. When it is known which operator interaction is next in line, specific actions may be taken to perform the corresponding operator interaction at the given time without delay and in an efficient manner.

Preferably, the production line includes a display device. For example, the display device may include a display screen. The display device may be provided at and/or attached to the production line, in particular to one of the work stations. Alternatively, the display device may be provided separately from the production line. The display device may be located in the same room as the production line. Alternatively, the display device may be provided outside a room where the production line is located. The display device may even be provided in a different building than the production line. The display device may be a stationary display device or a mobile display device. The central processing unit may be connected with the display device via a wireless or wired communication link. The communication link between the central processing unit and the display device may be established via a local communication protocol. The communication link between the central processing unit and the display device may be established via the Internet or via mobile communications.

The central processing unit may be configured to drive the display device to display the interaction times. By displaying the interaction times, operating the production line is facilitated for the operator. The operator is forewarned by displaying the interaction times and may make suitable arrangements and preparations in advance to perform the corresponding operator interaction in a timely and efficient manner.

The central processing unit may be configured to control the display device such that the interaction times are already displayed by a pre-warning duration before the time at which the respective corresponding operator interaction will be required in the future. The pre-warning duration may include at least one minute, or at least two minutes, or at least five minutes, or at least ten minutes, or at least fifteen minutes. The pre-warning duration may vary depending on the type of operator interaction and/or depending on the workstation.

The interaction times may be indicated by the display device, for example by displaying clock times corresponding to the particular time, at which the operator interaction is required. The display device may indicate the interaction times by indicating a time remaining until the respective interaction time is reached. The workstations or the central processing unit may be configured to determine the time remaining until the respective interaction time is reached.

The central processing unit may be configured to control the display device to display, for each interaction time, the type of operator interaction required at the interaction time. The display device may indicate the type of operator interaction, for example by displaying a designation of the operator interaction or by displaying an icon corresponding to the operator interaction. The display device may indicate the type of operator interaction, for example by displaying an indication, in particular a text, that allows the operator to infer the type of operator interaction.

The central processing unit may be configured to control the display device to display the interaction times in pairs together with the type of operator interaction required at the respective interaction time.

The central processing unit may be configured to control the display device to display, in addition to the interaction times, information indicating, at which workstation the respective operator interaction is to be performed.

The central processing unit may be configured to control the display device to indicate which operator interaction is due next. The central processing unit may be configured to control the display device to indicate which workstation is next in line for an operator interaction.

The central processing unit may be configured to determine a chronological order of operator interactions required in the future based on the time data. Knowing a chronological order of operator interactions required in the future facilitates timely and efficient execution of operator interactions. The central processing unit may be configured to control the display device so as to display the chronological order. This may be done, for example, by having the display device display the operator interactions arranged according to the chronological order.

The central processing unit may be configured to send electronic instruction messages based on the time data. The central processing unit may be configured to send electronic instruction messages based on the time data in combination with the interaction data. The electronic instruction messages may be sent to an operator, for example through a ticketing system or via email. By means of the instruction messages, the operator may be notified in a timely manner of the need for an operator interaction. The central processing unit may be configured to send the electronic instruction messages to a technical system. For example, the central processing unit may be configured to send the electronic instruction messages to an automated provisioning system. The automated provisioning system may be configured to provide resources required to perform the operator interaction in an automated manner. For example, the automated provisioning system may include an automated storage system.

Each of the workstations may include a dedicated controller. Alternatively or additionally, for example, one or more of the workstations may be controlled by the central processing unit. The central processing unit may be provided at one of the workstations or may be provided separately from the workstations.

The plurality of workstations may include one or more (or any combination) of: a portioning station, in particular a food slicer; a labelling device; a packaging machine; a station of a packaging machine. The packaging machine may be, for example, a thermoforming packaging machine or a traysealer or a form-fill-seal machine. The workstation of the packaging machine may include, for example, a thermoforming station or a sealing station or a cutting station of a packaging machine.

One or more of the workstations may include a state sensor. The time data may be the output values of the state sensor or may be determined based on the output values of the state sensor.

The state sensor may be configured to measure a value at the workstation indicative of a time of an operator interaction required in the future. For example, the state sensor may be configured to determine a fill level of a supply of material, such as by measuring a diameter of a supply roll. For example, the state sensor may be configured to determine a fill level of a waste receptacle, for example by measuring a diameter of a pickup roll. For example, the state sensor may be configured to determine a remaining supply of material, such as by counting pieces of material removed from the supply, such as by counting labels removed from a label supply. For example, the state sensor may be configured to determine a number of packages already produced or a number of products already processed, such as by counting the packages or products or by measuring a material usage.

The workstation or central processing unit may be configured to determine, based on the value determined by the state sensor, a time when an operator interaction with the respective workstation will be required in the future. This may be done by taking into account data stored in a memory or by taking into account settings or user inputs.

According to another aspect of the disclosure, there is provided a method of operating a production line for producing packaged products. In the method, a plurality of workstations of the production line is operated to perform different operations. In operation, the workstations anticipate time data that defines, as an interaction time, a time of an operator interaction with the respective workstation required in the future. The interaction times are displayed at a central display device.

Preferably, the time data is transmitted from the workstations to a central processing unit.

Preferably, the type of operator interaction required at the respective interaction time is displayed at the central display device along with each of the interaction times.

Displaying the interaction times at the central display device may include displaying a time remaining until the end of the respective interaction time.

A chronological order of operator interactions required in the future may be displayed at the central display device.

The operator interaction required in the future may include at least one of the following: replenishing consumables; changing a supply roll; emptying a waste receptacle; re-setting a machine; changeover of a machine; deactivation of a machine; cleaning of a machine; servicing of a machine.

As described, the disclosure relates to both a production line and a method of operating a production line. The production line may be adapted, suitable and/or configured to perform the method. The method may be performed on the production line or by the production line. Features and explanations described with respect to the production line may apply to the method and vice versa.

### BRIEF DESCRIPTION OF THE DRAWINGS

In the following, the disclosure is further explained by means of embodiments with reference to the figures.

FIG. 1 shows a schematic side view of a production line according to an embodiment; and

FIGS. 2 to 4 show schematic representations of a display device of the production line according to embodiments.

### DETAILED DESCRIPTION

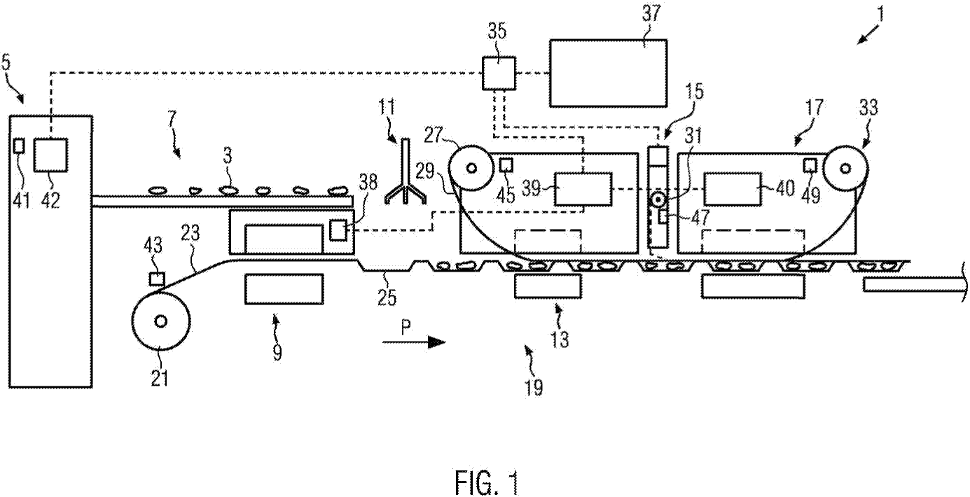

FIG. 1 shows a schematic view of a production line 1 for packaging products. The products may in particular be food products, for example sausages or cheese. The production line 1 includes several work stations for carrying out different work steps for producing packaged products. In the illustrated embodiment, the production line 1 includes the following work stations: a portioning station 5, a thermoforming station 9, a sealing station 13, a labelling device 15, and a cutting station 17.

The portioning station 5 is configured to divide the products to be packaged into portions 3. For example, the portioning station 5 may include a food slicer that slices products, such as sausages or cheese. A product conveyor belt 7 conveys the portions 3 from the portioning station 5 to a packaging machine 19, which includes the thermoforming station 9, a gripper robot 11, the sealing station 13 and the slicing station 17. In the packaging machine 19, a base foil web 23 removed from a base foil supply roll 21 of the thermoforming station 9 is conveyed along a production direction P. The thermoforming station 9, the gripper robot 11, the sealing station 13, the labelling device 15 and the cutting station 17 are arranged in series along the production direction P in the illustrated embodiment.

In the thermoforming station 9, packaging cavities 25 are formed in the base foil web 23 by thermoforming. For carrying out the deep-drawing, the thermoforming station 9 includes a forming die upper part and a forming die lower part, which cooperate for deep-drawing or thermoforming the base foil web 23. Downstream of the thermoforming station 9 with respect to the production direction P, the portions 3 are transferred from the product conveyor belt 7 into the packaging cavities 25 by the gripper robot 11. Downstream of the gripper robot 11 with respect to the production direction P, the packaging cavities 25 are sealed in the sealing station 13 by sealing a cover foil 29 taken from a cover foil supply roll 27 to the base foil 23. The sealing station 13 includes a sealing tool upper part and a sealing tool lower part, which cooperate to seal the base foil web 23 to the cover foil web 29. Sealing may be performed under the action of heat and/or pressure.

Downstream of the sealing station 13 with respect to the production direction P, the packages are provided with labels by the labelling device 15. The labels may be taken from a label supply roll 31. Downstream of the sealing station 13 and/or the labelling device 15 with respect to the production direction P, the closed packaging cavities 25 are separated from the foil composite by the cutting station 17. The cutting station 17 includes a residual foil rewinder, which is a waste receptacle 33. On the residual foil rewinder, remaining foil residues, in particular a foil residual grid, are rolled up after the separation of the packaging cavities 25.

The packaging line 1 includes a central processing unit 35 and a display device 37 that may be controlled by the processing unit 35. The display device 37 may include, for example, a display.

In the illustrated embodiment, each of the work stations includes its own control unit that controls some or all of the functions of the respective work station. However, this is not mandatory and, for example, multiple workstations may share a control unit or one, multiple or all of the workstations may be controlled by the central processing unit 35.

In the illustrated embodiment, the control unit 39 of the sealing station 13 is configured as the main control unit of the packaging machine 19 and is configured to coordinate the control units of the remaining work stations of the packaging machine 19. Communication between the central processing unit 35 and the control unit 38 of the thermoforming station 9 or the control unit 40 of the cutting station 17 is accomplished via the control unit 39 of the sealing station 13. Alternatively, the control unit 38 of the thermoforming station 9 and/or the control unit 40 of the cutting station 17 may communicate directly with the central processing unit 35, which is the case for the control unit 42 of the portioning station 5 in the illustrated embodiment.

The workstations are configured to predictively determine time data during operation that defines, as the interaction time, a time of an operator interaction with the respective workstation required in the future.

In the case of portioning station 5, the operator interaction may be, for example, a refilling of additional products. The portioning station 5 may include a product sensor 41 as a state sensor, which determines a quantity of a product to be portioned that is still present in the portioning station 5 at the respective time. Measurement data determined by the product sensor 41 defines a future point in time, at which the refilling of further products is required. The point in time may be calculated by taking into account the known product throughput of the packaging line 1.

In the case of the forming station 9, the operator interaction may be, for example, a change of the base foil supply roll 21. The forming station 9 includes a base foil supply roll sensor 43 that measures how much base foil 23 is left on the base foil supply roll 21. For this purpose, the base foil supply roll sensor 43 may measure, for example, a diameter or a radius of the base foil supply roll 21 at the respective time. Measurement data determined by the base foil supply roll sensor 43 defines a future time, at which a change of the base foil supply roll 21 is required. The time may be calculated by taking into account the known production rate of the packaging line 1.

In the case of the sealing station 13, the operator interaction may be, for example, a change of the cover foil supply roll 27. The sealing station 13 includes a cover foil supply roll sensor 45 configured to determine how much cover foil 29 remains on the cover foil supply roll 27. To do so, the cover foil supply roll sensor 45 may measure, for example, a diameter or a radius of the cover foil supply roll 27 at the particular time. Measurement data determined by the cover foil supply roll sensor 45 defines a future point in time when a change of the cover foil supply roll 27 is required. The time may be calculated by taking into account the known production rate of the packaging line 1.

In the case of the labelling device 15, the operator interaction may be, for example, a change of the label supply roll 31. The labelling device 15 includes a label roll sensor 47 configured to determine how many labels remain on the label supply roll 31. For this purpose, the label roll sensor 47 may count the number of labels removed, for example. Measurement data determined by the label roll sensor 47 defines a future time when a change of the label supply roll 31 is required.

In the case of the cutting station 17, the operator interaction may be, for example, changing or emptying the waste receptacle 33. The cutting station 17 includes a fill level sensor 49 configured to determine how much residual foil grid has already been rolled up on the waste receptacle 33. For this purpose, the fill level sensor 49 may measure, for example, a roll diameter or a roll radius of the rolled-up residual foil grid at the respective point in time. Measurement data determined by the fill level sensor 49 defines a future time, at which a change or emptying of the waste receptacle 33 is required. The time may be calculated by taking into account a maximum intake capacity of the waste receptacle 33.

The workstations transmit the time data to the central processing unit 35, which may be accomplished by transmitting the measurement data of the respective sensor as the time data. Based on the transmitted measurement data, the central processing unit 35 may then determine, in particular calculate, the respective future interaction time. Alternatively, the workstations may determine, based on the measurement data of the respective sensor, the respective future interaction time and transmit it to the central processing unit 35 as the time data.

In addition to the time data, the workstations transmit to the central processing unit 35 interaction data defining a type of operator interaction required at the corresponding interaction time. The interaction data may include an identifier associated with the operator interaction. The central processing unit 35 may be configured to associate, on the basis of a table, the identifier with an operator interaction.

The central processing unit 35 determines a chronological order of operator interactions required in the future based on the time data.

The central processing unit 35 controls the display device 37 to display the interaction times and associated operator interactions in chronological order. An operator is forewarned by displays of the interaction times before the interaction times occur, and he/she may make suitable arrangements and preparations in advance to perform the corresponding operator interaction in a timely and efficient manner.

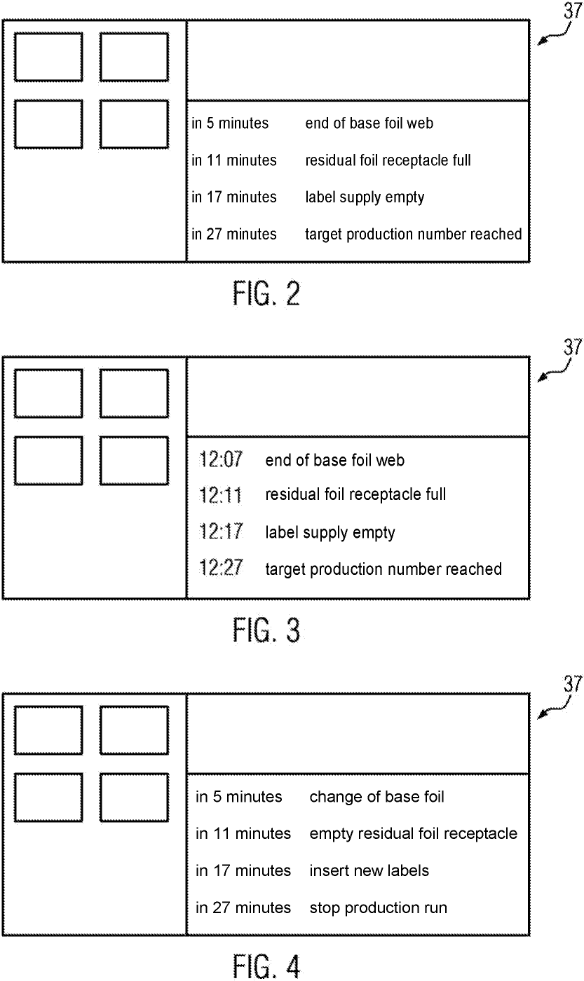

FIG. 2 shows a display of the display device 37 according to an embodiment, in which the interaction times are indicated by displaying a time remaining until the respective interaction time is reached. Next to each interaction time, it is indicated, by which event the predicted operator interaction is required. This corresponds to an indication of the type of operator interaction. For example, from the indication “end of base foil web”, the operator understands that the entry refers to the need to replace the base foil supply roll 21. The operator understands from the indication “foil residue receptacle full” that the entry refers to the requirement to empty or replace the waste receptacle 33. The entry “label supply empty” indicates to the operator that the entry refers to the need to replace the label supply roll 31. From the indication “target product quantity reached”, the operator understands that the entry refers to the requirement to stop the operation of the production line. Optionally, for each entry it may be indicated, at which workstation the respective operator interaction is to take place.

FIG. 3 shows the display of the display device 37 according to an alternative embodiment, in which the interaction times are indicated by displaying clock times corresponding to the particular time, at which the operator interaction is required. Except for the way of displaying the interaction times, the embodiment of FIG. 3 corresponds to the embodiment of FIG. 2.

FIG. 4 shows the display of the display device 37 according to another alternative embodiment, which is the same as FIG. 2 except for the display of the type of operator interaction. In the embodiment according to FIG. 4, it is explicitly displayed what the operator has to do in the respective operator interaction.

As those skilled in the art will understand, the central processing unit 35, display device 37, control units (e.g., control units 38, 39, 40, 42), sensors (e.g., sensors 41, 43, 45, 47, 49), workstations, as well as any other controller, unit, component, module, system, subsystem, interface, sensor, device, or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof and for performing the particular algorithm or algorithms represented by the various methods, functions and/or operations described herein, including interaction between and/or cooperation with each other. One or more of such processors, as well as other circuitry and/or hardware, may be included in a single Application-Specific Integrated Circuitry (ASIC) or Electronic Control Unit (ECU), or several processors and various circuitry and/or hardware may be distributed among several separate components, whether individually packaged or assembled into a System-on-a-Chip (SoC).

What is claimed is:

1. A production line for producing packaged products, the production line comprising:
a plurality of workstations for performing different work steps, wherein each of the workstations is configured to predictively determine, during operation, time data defining, as an interaction time, a time of an operator interaction with the respective workstation required in the future; and
a central processing unit, wherein the workstations are configured to transmit the time data to the central processing unit.

2. The production line according to claim 1, wherein the workstations are configured to communicate to the central processing unit interaction data corresponding to the time data, wherein the interaction data define a type of operator interaction required at the corresponding interaction time.

3. The production line according to claim 1, wherein the central processing unit is configured to determine a next upcoming operator interaction based on the time data from the workstations.

4. The production line according to claim 1, wherein the production line comprises a display device.

5. The production line according to claim 4, wherein the central processing unit is configured to control the display device so as to display the interaction times.

6. The production line according to claim 4, wherein the central processing unit is configured to control the display device so as to display interaction times by displaying a time remaining until the respective interaction time is reached.

7. The production line according to claim 4, wherein the central processing unit is configured to control the display device so as to display for each interaction time a type of operator interaction required at the interaction time.

8. The production line according to claim 4, wherein the central processing unit is configured to control the display device so as to indicate which operator interaction is due next.

9. The production line according to claim 1, wherein the central processing unit is configured to determine, based on the time data, a chronological order of the operator interactions required in the future.

10. The production line according to claim 9, wherein the production line comprises a display device, and the central processing unit is configured to control the display device to display the chronological order.

11. The production line according to claim 1, wherein the central processing unit is configured to send electronic instruction messages based on the time data.

12. The production line according to claim 1, wherein the plurality of workstations comprises one or more of the following: a portioning station, a labelling device, a packaging machine, a station of a packaging machine.

13. A method for operating a production line for manufacturing packaged products, the method comprising:
operating a plurality of workstations of the production line so as to perform different work steps;
predictively determining, by the workstations during operation, time data defining, as an interaction time, a time of an operator interaction with the respective workstation required in the future; and
displaying the interaction times at a central display device.

14. The method according to claim 13, wherein a type of operator interaction required at the interaction time is displayed at the central display device together with each interaction time.

15. The method according to claim 13, wherein displaying the interaction times at the central display device comprises displaying a time remaining until the respective interaction time is reached.

16. The method according to claim 13, wherein a chronological order of operator interactions required in the future is displayed at the central display device.

17. The method according to claim 13, wherein the operator interaction required in the future comprises at least one of: a replenishment of consumables, a supply roll change, an emptying of a waste receptacle, a re-setting of a machine, a changeover of a machine, a deactivation of a machine, a cleaning of a machine, or a servicing of a machine.
